(19) United States
(12) Patent Application Publication
(10) Pub. No.: US 2025/0224476 A1
(43) Pub. Date: Jul. 10, 2025

(54) ANGLE OF ARRIVAL ESTIMATION USING SUB-SYMBOL BEAM SWITCHING

(71) Applicant: International Business Machines Corporation, Armonk, NY (US)

(72) Inventors: Alexandra Gallyas Sanhueza, Chicago, IL (US); Arun Paidimarri, South Salem, NY (US); Sara Garcia Sanchez, White Plains, NY (US); Asaf Tzadok, New Castle, NY (US); Alberto Valdes Garcia, Chappaqua, NY (US)

(73) Assignee: International Business Machines Corporation, Armonk, NY (US)

(21) Appl. No.: 18/407,131

(22) Filed: Jan. 8, 2024

(51) Int. Cl. G01S 3/38

(52) U.S. Cl. CPC G01S 3/38

(57) ABSTRACT

An embodiment receives a data stream comprising a plurality of sets of wave samples over a defined period of time, wherein receiving the data stream comprises receiving a transmitted signal at a receiver device from a transmitter device, and wherein the receiver device comprises an antenna array. The embodiment adjusts a beam shape at the receiver a number of times while the transmitted signal is being received during the defined period of time using the antenna array, wherein adjusting the beam shape a number of times produces a modulated plurality of wave samples based on different beam shapes. The embodiment determines the angle of arrival of the transmitted signal based at least in part on the modulated plurality of wave samples.

### BACKGROUND

The present invention relates generally to digital communication and/or signal processing. More particularly, the present invention relates to a method, system, and computer program for angle of arrival estimation using sub-symbol beam switching.

Digital communication is a discipline of electronics concerning the development of processes of transmitting and receiving information using digital signals. In contrast to analog communication systems, which represent information in continuous signals, in a digital communication system, information is encoded in a discrete, digital form, which is typically represented in binary digits, i.e., bits. Information is often modulated onto carrier signals for transmission, and various modulation techniques are known that may be used to encode digital information onto analog carrier waves. Digital communication offers several advantages, including but not limited to, the ability to transmit and process information more reliability than analog communication, resistance to noise and interference, and offers the flexibility to be integrated with various types of data (e.g., voice, video, text, etc.).

Orthogonal frequency-division multiplexing (“OFDM”) is a type of digital transmission used in digital modulation for encoding digital data on multiple carrier frequencies. Accordingly, OFDM is a type of frequency-division multiplexing (“FDM”) scheme, such that all subcarrier signals within a communication channel are orthogonal to one another. In OFDM, the incoming bitstream representing the data to be sent is divided into multiple streams. Multiple closely spaced orthogonal subcarrier signals with overlapping spectra are transmitted, with each carrier modulated with bits from the incoming stream so multiple bits are being transmitted in parallel. A frequency domain representation of an OFDM symbol is constructed by assembling the individual sub-carriers and their modulated data. A time-domain representation is then constructed by applying Inverse Fast Fourier Transform (IFFT) on the frequency domain representation. An OFDM symbol in the time-domain is finally obtained by attaching a cyclic prefix to the result of the IFFT. In a receiver, the OFDM symbol is robust to inter-symbol interference and is spectrally efficient. In the receiver, Fast Fourier Transform (FFT) is applied along with additional signal processing to obtain the modulated data within each sub-carrier. OFDM has developed into a popular scheme for wideband digital communication, used in applications such as digital television and audio broadcasting, DSL internet access, wireless networks, power line networks, and 4G/5G mobile communications.

Digital signal processing is a field of electronics that involves the manipulation of digital signals. Accordingly, various digital signal processing techniques exist that may be utilized to analyze, modify, or generate digital signals to extract useful information and/or perform specific tasks. One specialized field of digital signal processing is known as Angle of Arrival (“AoA”) estimation, which may involve processing signals received by an antenna array. Accordingly, AoA estimation may involve determining a direction from which a signal wavefront in the far-field (e.g., radio wave, sound wave, etc.) arrives at a specific location. AoA estimation is utilized in various technological fields, including but not limited to, telecommunications, radar systems, and audio processing, and is primarily concerned with the determination of the direction of a signal source relative to a reference point.

### SUMMARY

The illustrative embodiments provide for angle of arrival estimation using sub-symbol beam switching. An embodiment includes receiving a data stream comprising a plurality of sets of wave samples over a defined period of time, wherein receiving the data stream comprises receiving a transmitted signal at a receiver device from a transmitter device, and wherein the receiver device comprises an antenna array. An embodiment includes embodiment adjusting a beam shape at the receiver a number of times while the transmitted signal is being received during the defined period of time using the antenna array, wherein adjusting the beam shape a number of times produces a modulated plurality of wave samples based on different beam shapes. An embodiment also includes determining the angle of arrival of the transmitted signal based at least in part on the modulated plurality of wave samples.

Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example system for wireless communication in accordance with an illustrative embodiment;

FIG. 2B depicts a block diagram of an example receiver device in accordance with an illustrative embodiment;

FIG. 3 depicts a block diagram of an example system for providing Angle-of-Arrival estimation using sub-symbol beam switching in accordance with an illustrative embodiment;

FIG. 4 depicts a waveform diagram of an example sequence of beam switched sets of wave samples;

FIG. 5 depicts a block diagram of an example process for estimating angle of arrival using sub-symbol beam switching in accordance with an illustrative embodiment;

FIG. 6 depicts a block diagram of an example process of a method for estimating angle of arrival of a signal with a known waveform using sub-symbol beam switching in accordance with an illustrative embodiment;

FIG. 7 depicts a block diagram of an example process of a method for estimating angle of arrival of a signal with an unknown waveform using sub-symbol beam switching in accordance with an illustrative embodiment; and

FIG. 8 depicts a flowchart of an example process for estimating angle of arrival using sub-symbol beam switching in accordance with an illustrative embodiment.

### DETAILED DESCRIPTION

According to an aspect of the invention, there is provided a computer-implemented method that includes the following steps. Accordingly, an aspect of the computer-implemented method includes receiving a data stream comprising a plurality of sets of wave samples at a receiver device from a transmitter device over a defined period of time. In an embodiment, the receiver device includes an antenna array. Another aspect of the computer-implemented method includes adjusting a beam shape at the receiver a number of times while the transmitted signal is being received during the defined period of time using the antenna array. In an embodiment, adjusting the beam shape a number of times produces a modulated plurality of wave samples based on different beam shapes. Another aspect of the computer-implemented method includes determining the angle of arrival of the transmitted signal based at least in part on the modulated plurality of wave samples. A technical advantage achieved due to the computer-implemented method includes the ability to achieve faster angle of arrival estimation that utilizes less hardware overhead and that involves less computational complexity compared to other currently existing methods for estimating angle of arrival.

In embodiments, the defined period of time is equivalent to the duration of a single communication symbol. A technical advantage achieved due to this aspect includes the ability to determine angle of arrival within the duration of a single communication symbol in contrast to determining an angle of arrival over the course of multiple communication symbols, resulting in a much faster determination of angle of arrival that requires less data acquisition than other currently existing methods for estimating angle of arrival.

In embodiments, the defined period of time the communication symbol is an orthogonal frequency-division multiplexing (OFDM) symbol. A technical advantage achieved due to this aspect includes faster beam alignment in 4G/5G contexts, thereby enabling lower spectrum use and lower power consumption.

In embodiments, an aspect of the computer-implemented method also includes a post-processing technique, such that the post-processing technique includes estimating and inverting gains or delays corresponding to each beam pattern. A technical advantage achieved due to this aspect includes more accurate estimation of angle of arrival.

In embodiments, the gains or delays are correlated with the beam pattern used during beam switching to calculate the angle of arrival. A technical advantage achieved due to this aspect includes a faster estimation of angle of arrival.

In embodiments an aspect of the computer-implemented method also includes extracting a sequence of weights from the modulated plurality of wave samples. A technical advantage achieved due to this aspect includes a reduction of computational complexity for estimation of angle of arrival.

In embodiments, determining the angle of arrival of the transmitted signal also includes applying the sequence of weights to an ideal waveform of the transmitted signal to create a modulated ideal waveform, and comparing the modulated ideal waveform to the plurality of sets of wave samples to determine the angle of arrival corresponding to each set of the plurality of sets of wave samples. A technical advantage achieved due to this aspect includes more accurate estimation of angle of arrival.

In embodiments, an aspect of the computer-implemented method also includes establishing a mapping between a plurality of sequences of weights and a plurality of angles of arrival corresponding to the plurality of sequences of weights and comparing the sequence of weights extracted from the modulated plurality of wave samples against the mapping to determine the angle of arrival. A technical advantage achieved due to this aspect includes a reduction of computational resources required for estimation of angle of arrival.

In embodiments, the transmitted signal is received at the receiver device from a plurality of signal paths, and an aspect of the computer-implemented method also includes determining a plurality of angles of arrival corresponding to the plurality of signal paths. A technical advantage achieved due to this aspect includes the ability to determine multiple angles or arrival, thereby also enabling imaging on an environment.

According to another aspect of the invention, there is provided a computer program product that includes one or more computer readable storage media, and program instructions collectively stored on the one or more computer readable storage media, such that the program instructions are executable by a processor to cause the processor to perform the following operations. Accordingly, an aspect of the computer program product includes program instructions to receive a data stream comprising a plurality of sets of wave samples at a receiver device from a transmitter device over a defined period of time. In an embodiment, the receiver device includes an antenna array. Another aspect of the aspect of the computer program product includes program instructions to adjust a beam shape at the receiver a number of times while the transmitted signal is being received during the defined period of time using the antenna array. In an embodiment, adjusting the beam shape a number of times produces a modulated plurality of wave samples based on different beam shapes. aspect of the computer program product includes program instructions to determine the angle of arrival of the transmitted signal based at least in part on the modulated plurality of wave samples. A technical advantage achieved due to the computer program product includes the ability to achieve faster angle of arrival estimation that utilizes less hardware overhead and that involves less computational complexity compared to other currently existing methods for estimating angle of arrival.

In embodiments, the stored program instructions are stored in a computer readable storage device in a data processing system, and the stored program instructions are transferred over a network from a remote data processing system. A technical advantage achieved due this aspect includes the ability to remotely execute the program instructions.

In embodiments, the stored program instructions are stored in a computer readable storage device in a server data processing system, and the stored program instructions are downloaded in response to a request over a network to a remote data processing system for use in a computer readable storage device associated with the remote data processing system. In embodiments the program instructions include program instructions to meter use of the program instructions associated with the request and program instructions to generate an invoice based on the metered use. A technical advantage achieved due this aspect includes more efficient utilization of a hardware storage device.

In embodiments, the defined period of time is equivalent to a duration of a single OFDM communication symbol. A technical advantage achieved due to this aspect includes the ability to determine angle of arrival within the duration of a single communication symbol in contrast to determining an angle of arrival over the course of multiple communication symbols, resulting in a much faster determination of angle of arrival that requires less data acquisition than other currently existing methods for estimating angle of arrival.

In embodiments, the program instructions of the computer program product also include program instructions to perform a post-processing technique, such that the post-processing technique includes estimation and inversion of the gains or delays corresponding to each beam pattern. A technical advantage achieved due to this aspect includes more accurate estimation of angle of arrival.

In embodiments, the gains or delays are correlated with a beam pattern used in beam switching to calculate the angle of arrival. A technical advantage achieved due to this aspect includes a faster estimation of angle of arrival.

In embodiments, the program instructions of the computer program product also include program instructions to extract a sequence of weights from the modulated plurality of wave samples. A technical advantage achieved due to this aspect includes a reduction of computational complexity for estimation of angle of arrival.

In embodiments, determining the angle of arrival of the transmitted signal also includes applying the sequence of weights to an ideal waveform of the transmitted signal to create a modulated ideal waveform, and comparing the modulated ideal waveform to the plurality of sets of wave samples to determine the angle of arrival corresponding to each set of the plurality of sets of wave samples. A technical advantage achieved due to this aspect includes more accurate estimation of angle of arrival.

In embodiments, the program instructions of the computer program product also include program instructions to establish a mapping between a plurality of sequences of weights and a plurality of angles of arrival corresponding to the plurality of sequences of weights and program instructions to compare the sequence of weights extracted from the modulated plurality of wave samples against the mapping to determine the angle of arrival. A technical advantage achieved due to this aspect includes a reduction of computational resources required for estimation of angle of arrival.

According to another aspect of the invention, there is provided a computer system that includes a processor, one or more computer readable storage media, and program instructions collectively stored on the one or more computer readable storage media, such the program instructions are executable by the processor to cause the processor to perform the following operations. Accordingly, an aspect of the computer system includes program instructions to receive a data stream comprising a plurality of sets of wave samples at a receiver device from a transmitter device over a defined period of time. In an embodiment, the receiver device includes an antenna array. Another aspect of the aspect of the computer system includes program instructions to adjust a beam shape at the receiver a number of times while the transmitted signal is being received during the defined period of time using the antenna array. In an embodiment, adjusting the beam shape a number of times produces a modulated plurality of wave samples based on different beam shapes. Another aspect of the computer system includes program instructions to determine the angle of arrival of the transmitted signal based at least in part on the modulated plurality of wave samples. A technical advantage achieved due to the computer-implemented method includes the ability to achieve faster angle of arrival estimation that utilizes less hardware overhead and that involves less computational complexity compared to other currently existing methods for estimating angle of arrival.

In embodiments, the computer system also includes program instructions to extract a sequence of weights from the modulated plurality of wave samples, establish a mapping between a plurality of sequences of weights and a plurality of angles of arrival corresponding to the plurality of sequences of weights, and compare the sequence of weights extracted from the modulated plurality of wave samples against the mapping to determine the angle of arrival. A technical advantage achieved due to this aspect includes a reduction of computational resources required for estimation of angle of arrival.

Angle-of-Arrival (“AoA”) estimation is a process of determining the direction of propagation of a signal incident on measuring location (e.g., an antenna array). AoA estimation is used in various wireless communication applications, including but not limited to, security, navigation (e.g., localization and tracking), enhanced and efficient beamforming, and multi-user scheduling. Some currently existing methods of AoA estimation may rely on processing multiple parallel RF data streams (i.e., multiple RF chains). Alternatively, some other currently existing methods of AoA estimation may rely on the use of mechanically rotating antennas, or searching across pre-defined beam options over long periods of time.

In contrast to currently existing methods for AoA estimation, an embodiment of the present disclosure includes a method for AoA estimation that includes utilization of fast beamforming and single RF-chain processing. An advantage of said embodiment includes the achievement of AoA estimation that does not depend on hardware overheard, involves low computational complexity, and that may utilize a single orthogonal frequency division multiplexing (“OFDM”) symbol.

There are a number of currently existing methods for estimating angle of arrival of a transmitted signal. However, as mentioned, current methods for AoA estimation may require substantial hardware overhead, and likewise current methods tend to be very slow as they may experience high latency. For example, current methods for AoA estimation may require digitalization of multiple RF chains, which increases the overall power consumption of the system, and increases data bandwidth for the computation and processing within the system. Other current methods might provide AoA estimation using digitization of a single RF chain, but these methods operate over multiple communication symbols, resulting in higher latencies. Despite improvements in wireless communication and signal processing technology, there is presently no existing way to determine an angle of arrival of a signal within a single communication symbol using a single RF chain.

The present disclosure addresses the deficiencies described above by providing a process (as well as a system, method, machine-readable medium, etc.) that estimates angle of arrival using sub-symbol beam switching. Disclosed embodiments consider utilization of a receiver including a phased array system with fast beamforming capabilities configured to adjust a direction of a beam multiple times across the course of a single communication symbol.

The illustrative embodiments provide for angle of arrival estimation using sub-symbol beam switching. Angle of arrival (or simply “AoA”) as referred to herein refers to the direction at which a signal is received at a receiver device from a transmitter device. Embodiments disclosed herein describe the signal as an electromagnetic signal, and in some specific embodiment, as an radio frequency (“RF”) signal; however, use of this example is not intended to be limiting, but is instead used for descriptive purposes only. Instead, the signal can include signals of any frequency across the electromagnetic spectrum.

As used throughout the present disclosure, the term “symbol” refers to a waveform sequence of a particular length, such that the length is equivalent to the smallest waveform sequence that can be considered for the purpose of beam switching, as described in greater detail herein. For example, in the context of OFDM, a single OFDM symbol comprises the smallest waveform sequence that can be considered for beam switching. Although it is understood that “symbols”, in the context of digital communication, typically refer to finite sets of discrete values used to represent information (typically binary, taking on the value of either 0 or 1) and the combination of such symbols form sequences of symbols that enable the representation of more complex information, this is not the definition of “symbols” as discussed here in relation to embodiments of the present disclosure. Instead, as stated above, a “symbol” shall refer to a waveform sequence of a sufficient length for the performance of beam switching operations thereon.

Further, although embodiments disclosed herein describe the symbol as an OFDM symbol, the use of this example is not intended to be limiting, but is instead used for descriptive purposes only. Modifications, such as the type of symbol, are considered within the scope and spirit of the present disclosure. For example, in the context of single-carrier modulation (in contrast to multiple-carrier modulation), an embodiment may include the utilization a data packet of a particular size as a unit or “symbol” over which beam switching operations are performed. As another example, in the context of radar waveforms, an embodiment may include the utilization of a single chirp as the “symbol” over which beam switching operations are performed.

In an embodiment of the present disclosure, a receiver device performs fast beam switching to determine the angle of arrival (“AoA”) of a received signal. In an embodiment, the proposed process (as well as a system, method, machine-readable medium, etc.) leverages a phased array antenna system with beam switching capabilities to dynamically adjust measured beam formations. In an embodiment, the process includes receiving via a receiver device a signal transmitted from a transmitter device from an unknown location at an unknown angle of arrival. In some such embodiments, the receiver includes a phased array antenna system, and the process further includes manipulating the phase of a signal received by different elements in the phased array antenna to achieve particular beamforming and beam steering. Accordingly, beamforming at the receiver device may include applying phase shifts to each antenna element of a phased array antenna system (analog beamforming), and/or to different data streams (digital beamforming). Further, the phase shift per antenna element enables the receiver to capture the received signal in specific angular directions. When beamforming at the receiver device is performed for multiple beams within a predefined period of time, the received signal is weighted/modulated by the receiver beams. In an embodiment, the predefined time period corresponds to the duration of a single OFDM symbol.

As used throughout the present disclosure, the term “beam” refers to a profile of gain applied by a receiver as a function of the angle of an incoming electromagnetic wave. Further, the shape of a beam may be determined by the directional characteristics of antennas that may be designed to receive signals from a specific direction. Embodiments of the present disclosure include adjusting the beam shape of a beam at the receiver end of a wireless communication system via a phased array antenna system incorporated as part of a receiver device.

As used throughout the present disclosure, the term “phased array antenna system” refers to an antenna system that includes an array of antenna elements and an adjustable phase shifter that may be configured to steer a beam electronically. In an embodiment of the present disclosure, a receiver device configured with a phased array antenna system is utilized to steer a beam electronically. Accordingly, by adjusting the phase of the signals across the array, the direction of the main lobe may be controlled, which may enable control over the direction that the received signal that is measured with the highest gain. In some embodiments, both phase shift and gains are applied to the signals at each antenna. Gains applied to the signal at each antenna provides a windowing function that, for example, impacts the levels of sidelobes seen in the beam shapes. Embodiments of the present disclosure describe the receiver device as comprising a phased array antenna system; however, the use of this example is not intended to be limiting, but is instead used for descriptive purposes only. Modifications, such as the type of antenna configuration, are considered within the scope and spirit of the present disclosure. Accordingly, any antenna system that is configurable to dynamically affect the gain of a received signal is considered herein. For example, in some embodiments, the antenna system may also comprise an antenna that may be configurable to electronically adjust the antenna's reflectors as a means to adjust gain of the received signal, or may also include a mechanically adjustable antenna. For example, in some embodiments, fully digital beamforming arrays or hybrid beamforming arrays are also considered herein.

Further, since a phased array antenna system at a receiver does not physically change the angle of arrival of a received signal, the phased array antenna system utilizes phase shifts to adjust a beam shape. Accordingly, the signal that propagates in space does not have a shape by itself. In a phased array antenna system, individual antenna elements may be equipped with phase shifters, which can be adjusted to control the phase of the incoming signals at each antenna element. The array can electronically steer its main lobe to a specific angle without physically moving the antennas. A phased array antenna at the receiver doesn't change the actual angle of arrival of a received signal; instead, the system adjusts the phase relationships between signals received by different elements to achieve beamforming and control the directionality of the array. While a phased array antenna system incorporated into the receiver may not alter the physical angle from which a signal arrives, the system effectively changes the direction of maximum sensitivity or gain of the array. Accordingly, the phases applied to each antenna element create a beam shape for the received signal, which results in a gain that is a function of angle of arrival with respect to the antenna array. Thus, the actual gain applied to the received signal is a function of the actual angle of arrival and the beam shape.

As used throughout the present disclosure, the term “beamforming” refers to a signal processing technique used for directional signal transmission or reception, typically implemented via sensor arrays. Beamforming may be achieved by combining elements in an antenna array in such a configuration that signals at particular angles experience constructive interference while signals at other angles experience destructive interference. Although beamforming may be implemented at both the transmitting and receiving ends in order to achieve spatial selectivity, embodiments of the present disclosure contemplate beamforming at a receiver device of a wireless communication system. Embodiments of the present disclosure contemplate the inclusion of a phased array antenna system incorporated into a receiver device, which may be configured so that applying phase shifts to each antenna element in the phased array causes per-antenna element phase shift that enables the receiver to capture the received signal in specific angular directions. Each antenna element of the phased array antenna system of the receiver receives a uniquely phased shifted and/or amplified version of the signal received, thereby constructively forming a beam in a particular direction. Accordingly, beamforming may include adjusting the phase and/or amplitude of signals received at multiple antennas to create a constructive interference pattern in a specific direction.

As used throughout the present disclosure, the term “beam switching” refers to the process of changing the beam used by the receiver phased array. For example, in an embodiment, the direction of peak gain may be switched. As another example, in an embodiment, the direction of a null is moved, or a beam shape with multiple peaks may be used. The phases and/or gains applied to the signal at each antenna in the array may be adjusted cause the change of the beam shape of the aggregated signal at the output of the array. The electromagnetic waves received by the array in its field of view are amplified and phase shifted/delayed based on the gain profile of each of the beam used in the beam switching. Beam switching is typically used in the context of antennas, such as, for example, a phased array system, as described above. Accordingly, a phased array antenna system may be configured to electronically steer beams without physically repositioning parts of the antenna system structure. In the context of the present disclosure, the phase or timing of the signals received at different elements within the array is adjusted, and by changing these phase relationships, the combined signals create a new beam direction. The rapid speed of electronic steering via beam switching enables dynamic adaptation to changing conditions, as well as enables tracking of moving targets. Embodiments of the present disclosure include rapidly switching receiver beam shapes over a period of time. For each beam shape, the gain applied by the receiver is a function of the angle of arrival, which may be unknown, and the beam shape, which may be known. A particular pattern of phase shifts will cause a particular sequence of beam shapes over a period of time. As the receiver beam shapes change over time, so does the effective gain of the receiver. Accordingly, there is a set of weights applied to the received signal caused from performing beam switching. In some embodiments of this disclosure, the weights applied by the receiver over a period of time are determined using the waveform of the received beam modulated signal. Some embodiments use these sets of weights to estimate the angle of arrival of the transmitted signal. These embodiments and methods are described in greater detail herein the present disclosure. The set of weights applied to the waveform associated with each beam may include gain and phase/delay.

Illustrative embodiments include receiving a signal at a receiver device transmitted from transmitter device. In an embodiment, the receiver device includes a phased array antenna system configured to perform rapid beam switching of the beam used by the receiver to measure an incoming beam received from the transmitter device. In some such embodiments, the phased array antenna system is configured to adjust the phase or timing of the signal received at each antenna element within the phased array antenna system.

Illustrative embodiments further include receiving a data stream corresponding to the transmitted signal. In an embodiment, when an analog electromagnetic signal is transmitted from the transmitter device and is received by a receiver device, an analog-to-digital (“ADC”) converter may be utilized to convert the analog signal into a digital bit representation of the analog signal. Further, the data stream comprises the digital signal (i.e., the digital bit representation of the analog signal), which comprises a plurality of sets of wave samples corresponding to the received signal. In an embodiment, the data stream corresponding to the received signal is modulated according to the beamforming gains created from performing beam switching during reception of the signal. Accordingly, the receiver receives a signal, which is referred to herein as a received signal. The received signal is modulated according to the beam switching performed while the signal is being received, thereby creating a beam-modulated signal. The beam-modulated signal is converted, via the ADC, to a digital bit representation that reflects a gain profile produced from the beam switching operations performed during reception of the signal.

Illustrative embodiments further include performing a beam switching process multiple times during the reception of the signal within the duration of a predetermined period of time. In an embodiment, the process adjusts the shape of a beam formation a number of times for the duration of a single communication symbol. In an embodiment, the process steers the beam formation using a receiver that includes a phased array system capable of rapidly steering the beam over multiple directions within the duration of the symbol. Further, for every beam direction that is configured, there is a gain profile created for each direction. In some embodiments, the gain profile, also called a beam pattern, is calculated from theory, and in other embodiments, it is characterized experimentally. Accordingly, depending on the angle of incidence or AoA, the receiver experiences a different gain depending on the gain profile of the current beam. Thus, it is understood that amplitude of the waveform is dependent in part on the shape of the beams that are chosen during beam switching operations as well as the actual AoA of the received signal. In some embodiments the gain profile may include both amplitude and phase. In some embodiments, when beams are generated using linear phase slopes, the resulting gain profile is sinc-shaped and thus only has a real-value, or equivalently with 0 degree or 180 degree phases.

Illustrative embodiments further include calculating a sequence of weights based at least on the result of the beam switching operations performed. Accordingly, since each beam shape has an impact on the measured gain, each set of samples corresponding to each beam direction, respectively, may be associated with a particular weight. An embodiment of the disclosed process calculates a weight based on the gain for each set of wave samples, and constructs a sequence of weights, wherein the sequence of weights comprises one weight for each beam shaped formed.

Illustrative embodiments further include applying a sequence of weights to an ideal sequence of a waveform to create a modulated ideal waveform sequence. In a particular embodiment, the waveform of the transmitted signal is known. In some such embodiments, a sequence of weights is applied to the ideal sequence of the known waveform to construct a beam switching modulated ideal sequence that may be compared to measured sets of received wave samples. In some embodiments, the sequence of weights to apply to the ideal waveform sequence is obtained by selecting the gain for each beam in the beam sequence along an estimated direction of the AoA.

Illustrative embodiments further include comparing the modulated ideal sequence of the waveform of the signal to the actual measured waveform of the signal. In an embodiment, comparing the modulated ideal sequence of the waveform of the transmitted signal to the actual measured waveform of the transmitted signal may include correlating the modulated ideal sequence to the measured sequence to determine an angle of arrival that would generate beam switched samples that most similarly resemble the measured samples for the steered beams. In some embodiments, several modulated ideal sequences are compared to the measured samples, each corresponding to different potential AoAs. Illustrative embodiments further include outputting recovered signal samples (without weights) for utilization in higher protocol level wireless communication processing as well as the estimated angle of arrival.

Illustrative embodiments further include constructing a mapping between sets of weights utilized to modulate an ideal signal and angles of arrival that would cause an ideal signal to resemble to the modulated ideal signal. Since signal gain is dependent on the angle of arrival of a signal at a receiver device, a mapping may be constructed that defines a signal gain sequence to a particular angle of arrival for the specific set of beams that are used in the beam switching. Accordingly, in some embodiments, when a set of weights are estimated for the samples for each beam, the mapping may be used to estimate the angle of arrival. Such an estimation is an inversion of the created mapping.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

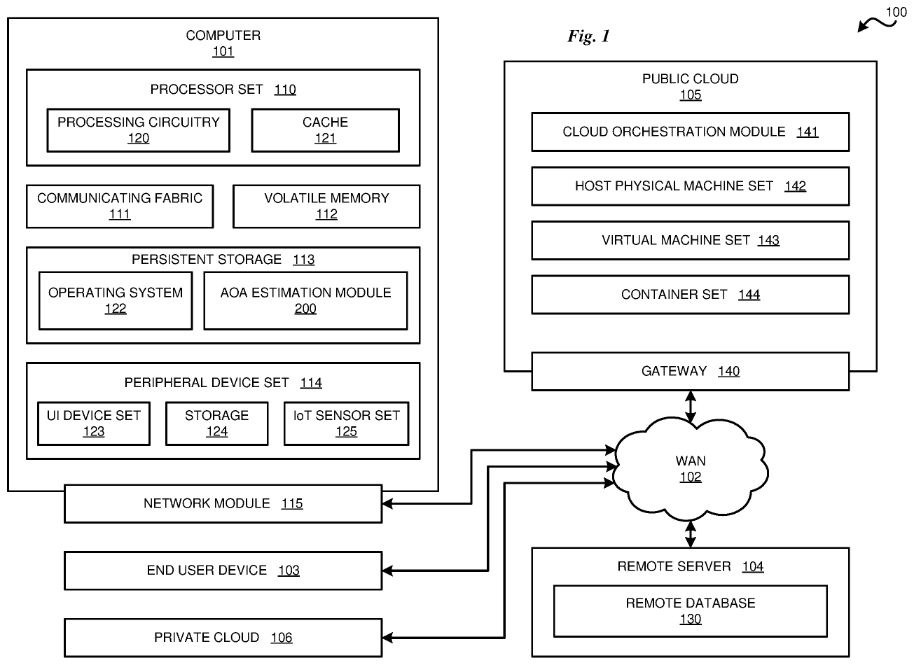

With reference to FIG. 1, this figure depicts a block diagram of a computing environment 100. Computing environment 100 contains an example of an environment for the execution of at least some of the computer code involved in performing the inventive methods, such as an AoA estimation module 200 that determines an angle of arrival of a transmitted signal based at least in part on a beam switching technique. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

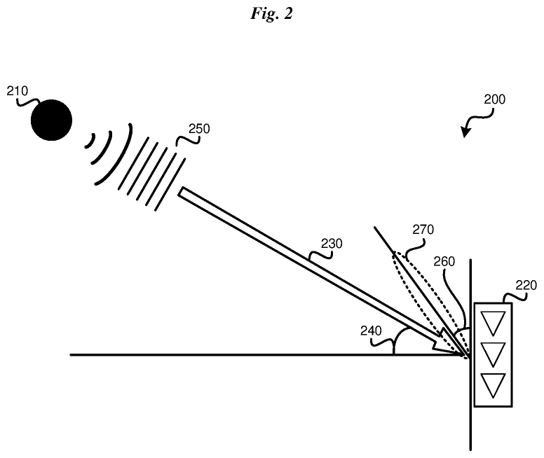

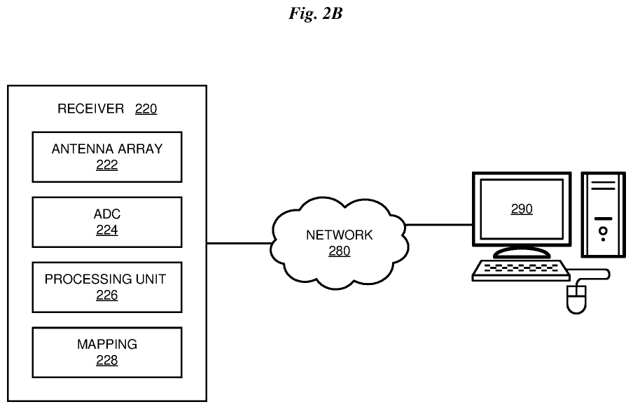

With reference to FIG. 2, this figure depicts a diagram of an example system 200 for wireless communication. In the illustrated embodiment, a transmitter device 210 is shown transmitting an electromagnetic signal to a receiver device 220. In the illustrated embodiment, the transmitter device 210 is shown transmitting an electromagnetic signal with a wavefront 250. In some embodiments, the transmitter device 210 includes at least one antenna. In some embodiments, the receiver device 220 likewise includes at least one antenna. In a particular embodiment, the receiver device 220 includes more than one antenna, i.e., an antenna array. In the illustrated embodiment, the receiver device 220 includes an antenna array. In some such embodiments, the receiver device 220 may include a phased array antenna system.

In some embodiments, the transmitter device 210 transmits a signal in a directive manner to receiver device 220. In some other embodiments, transmitter device 210 transmits a signal in an omnidirectional manner to receiver device 220. It is contemplated herein that example processes for estimating angle of arrival disclosed herein may be performed in the same manner regardless of whether the transmitter device 210 transmits a signal in a directive manner or in an omnidirectional manner. Further, regardless of whether the transmitter device 210 is directional or omnidirectional, there is nevertheless a unique wavefront 250 transmitted towards and received by the receiver device 220.

Further, in the illustrated embodiment, the wavefront 250 of the signal transmitted from transmitter device 210 s depicts electromagnetic waves being transmitted in a particular direction 230 and being received by receiver device 220. Further, in the illustrated embodiment, signal is depicted as being received by receiver device 220 at a particular angle of arrival 240. In some embodiments, the receiver antenna array of the receiver device 220 is planar. In some such embodiments, the AoA is measured with respect to a notional reference plane that is orthogonal to the surface of the receiver antenna array. In some embodiments, the location of the transmitting device 210 is unknown and the angle of arrival 240 is unknown.

In accordance with the illustrated embodiment, an embodiment of the present disclosure is configured to estimate the angle of arrival 240 of the transmitted signal 250 that is received by a receiver device 220 from the transmitting device 210. Accordingly, a determination of the angle of arrival 240 enables discovery of the direction from which the transmitting device 210 is transmitting a signal. A determination of the angle of arrival 240 improves the capability the receiver device 220 to receive the transmitted signal, as well as is useful for a number of other applications contemplated herein.

In the illustrated embodiment, the receiver 220 may be configured to steer the direction 260 of the received beam 270 formed by the receiver 220 via a beam steering technique. Accordingly, the beam steering may include dynamically adjusting the direction of the main lobe (i.e. the direction of maximum receiver gain) of the phased array antenna system of receiver device 220. Further, in an embodiment, the receiver device 220 may be configured to perform a beam switching pattern over a period of time, and the result of the beam switching pattern may be used in part to estimate the angle of arrival 240 of the beam 270. Accordingly, the receiver device 220 may include a phased array system configured to perform a beamforming technique in the receiver device 220, thereby enabling the receiver device 220 to dynamically steer the reception pattern of the transmitted signal 230 in different directions 260.

In the illustrated embodiment, the receiver device 220 may perform a beam switching process a number of times within a predetermined period of time. In an embodiment, the predetermined period of time includes the duration of a communication symbol. In some such embodiments, the communication symbol includes a single orthogonal frequency-division multiplexing (OFDM) symbol.

Further, for the sake of clarity, in the illustrated embodiment a single signal path is depicted in FIG. 2. However, use of this example is not intended to be limiting. Accordingly, it is contemplated that certain embodiments of the present disclosure consider scenarios that may include multiple signal paths, as described in greater detail herein. Accordingly, in environments that include multiple signal paths, the electromagnetic waves from the transmitter device 210 may have reflections, refractions, and/or diffractions from objects, and may reach the receiver array of the receiver device 220 from multiple directions.

With reference to FIG. 2B, this figure depicts a block diagram of an example receiver device in accordance with an illustrative embodiment. In the illustrated embodiment, receiver device 220 of FIG. 2B may include receiver device 220 of FIG. 2.

In the illustrated embodiment, the receiver device 220 is shown including an antenna array 222, an analog-to-digital converter (ADC) 224, a processing unit 226, and a mapping module 228. In the illustrated embodiment, the antenna array 222 is configured to receive an analog signal that is transmitted from a transmitter device (not shown) from an unknown direction in an unknown location. In the illustrated embodiment, the processing unit 226 may be configured to execute instructions stored on a memory to perform some or all of the operations disclosed herein. In an embodiment, the processing unit 226 may include, but is not limited to, an application specific integrated circuits (ASIC), a field programmable gate array (FPGA), an embedded micro-processor, a GPU, an AI accelerator, or any combination thereof. In the illustrated embodiment, receiver device 220 is shown communicatively connected to computer system 290 via network 280. In some embodiments, computer system 290 may perform some or all of the operations performed by processing unit 226. For example, in an embodiment, receiver device 220 may receive an analog signal via the antenna array 222 and convert the analog signal to a digital signal via the ADC 224, and the remaining processing may be accomplished offsite via computer system 290 either in place of or in addition to processing unit 226.

In the illustrated embodiment, receiver device further includes a mapping module 228 stored on onboard memory. In an embodiment, the mapping module 228 is a software module configured to construct a mapping between sequences of gains/weights corresponding to specific beam switching patterns, and angles of arrival that would produce such gains/weights while measuring a received a signal. In an embodiment, the mapping module 228 further identifies an angle of arrival of a received signal based on the comparing the sequence of gains/weights extracted from the received signal, and sequences of gains/weights stored in the mapping, to determine an angle of arrival defined by a particular sequence of gains/weights. In an embodiment, the mapping module 228 is also implemented in hardware, or as a hardware accelerator, or utilize ASIC, FPGA, GPU or AI accelerators.

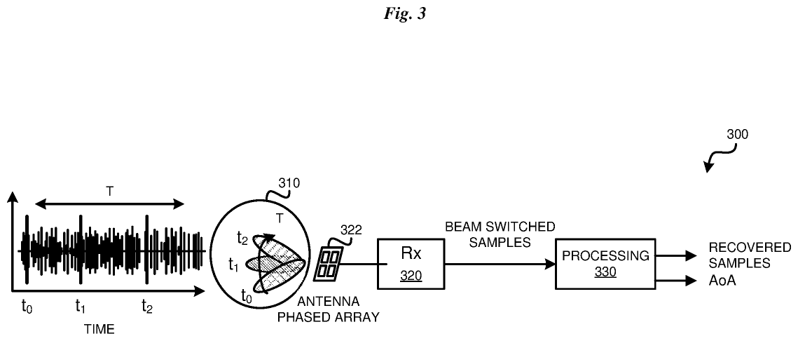

With reference to FIG. 3, this figure depicts a block diagram of an example system 300 for providing Angle-of-Arrival estimation using sub-symbol beam switching in accordance with an illustrative embodiment. In the illustrated embodiment, the processing device 330 may include AoA estimation module 200 of FIG. 1, processing unit 226 of FIG. 2B, and/or any other suitable computer architecture configuration which may process the computations involved in estimating the angle of arrival. In alternative embodiments, the processing device 330 can include some or all of the functionality described herein but grouped differently into one or more modules. In some embodiments, the functionality described herein is distributed among a plurality of systems, which can include combinations of software and/or hardware-based systems.

In the illustrated embodiment, receiver device 320 receives a transmitted signal from a transmitter device (not shown). The transmitted signal that is received by the receiver device 320 is depicted in the diagram as a function of time, such that the duration of time is equivalent to duration of a single communication symbol (T). In an embodiment, receiver device 320 receives an analog signal transmitted from a transmitter device, and converts the analog signal to a digital bit representation of the analog signal via an analog to digital converter (ADC). In some such embodiments, the receiver device 320 receives a data stream comprising a plurality of sets of wave samples over a period of time, such that the plurality of sets of wave samples are representative of the received signal. In an embodiment, the period of time is equivalent to the duration of a single communication symbol corresponding to the signal. In an embodiment, the communication symbol includes an orthogonal frequency-division multiplexing (OFDM) symbol. In the illustrated embodiment, the receiver device 320 includes a phased array antenna system 322, such that the phased array antenna system 322 includes a plurality of individual antenna elements. Accordingly, the receiver device 320 is configured to perform a beam switching procedure via the phased array antenna system 322 during the reception of the signal, so that the receiver 320 receives modulated/weighted sets of wave samples corresponding to each different beam shape.

In the illustrated embodiment, a single communication symbol (T) being received is shown. Further, each of time t(0), t(1), and t(2) depict a specific period of time during which the signal is measured within the duration of T. Further, at each of time t(0), t(1), and t(2), a different beam shape is measured, such that each of time t(0), t(1), and t(2) corresponds to a different received beam shape. Accordingly, time t(0) corresponds to a period of time during which the transmitted signal is measured at a first configuration of the phased array antenna elements 322, time t(1) corresponds to a period of time during which the transmitted signal is measured at a second configuration of the phased array antenna elements 322, and time t(2) corresponds to a period of time during which the transmitted signal is measured at a third configuration of the phased array antenna elements 322. Accordingly, each of t(0), t(1), and t(2) represents a period of time occurring over the duration of communication symbol T, such that each of t(0), t(1), and t(2) represent a separate sub-symbol of communication symbol T.

Accordingly, each beam shape of t0, t1, and t2 are formed via the phased array antenna system 322, by adjusting the beam that captures the transmitted signal. Since the transmitted signal itself is not controlled, the phased array antenna system 322 adjusts the manner in which the signal is measured. In an embodiment, the beamformer adjusts the shape of the beam received by the receiver 320 by utilizing a phase shift technique of the different antenna elements of phased array antenna system 322 configured to receive the transmitted signal(s). As shown in the figure, a plurality of beam shapes 310 are configured by the phased array antenna system 322. Further, each beam shape of the plurality of beam shapes 310 may include a unique beam shape.

In the illustrated embodiment, the system 300 produces a plurality of beam switched sets of wave samples, such that each set of wave samples are captured with a different beam shape caused by the phased array antenna system 322. In an embodiment, the phased array antenna system 322 is capable of rapid beamforming, such that a plurality of different measurement directions for the transmitted signal may be accomplished within a single communication symbol duration of time. Accordingly, each beam modulates the amplitude and/or phase of a set of wave samples received by the receiver device 320, according to the particular angular direction that is configured via a phase shift pattern applied to each antenna in the array. Further, since the beams are swept over time, and since each different beam shape modulates the received signal, the system 300 produces a sequence of weights, and each weight of the sequence of weights may be applied to the set of samples that are captured with each beam.

In the illustrated embodiment, the plurality of beam switched sets of samples are processed by processing device 330 to determine an angle of arrival of the transmitted signal as well as to recover the unweighted sets of samples, as described in greater detail herein. In an embodiment, processing device 330 includes a processor, a memory, and a set of instructions stored on the memory, that when executed by the processor, cause the processing device 330 to perform the following example operations to estimate the angle of arrival of a received signal. In some embodiments, the processing device 330 includes a custom accelerator as part of an application specific integrated circuit (ASIC) to perform the following example operations to estimate the angle of arrival of a received signal. For example, the set of instructions may include, upon receiving the sets of beam switched samples, converting the analog signals to a digital signal via an analog-to-digital converter (“ADC”). Further, multiple sets of wave samples are collected during the beam switching process, wherein each set of wave samples captures a variation in a received signal as the phased array antenna system dynamically adjusts its beam. For example, a first set of wave samples may be obtained during t(0), a second set of wave samples may be obtained during t(1), and a third set of wave samples may be obtained during t(2). Since each beam has an impact on the gain and/or phase of the signal, the system 300 may produce a sequence of weights based on the gain and/or phase experienced by each of the set of wave samples obtained during transmission of a signal for a single communication symbol. In a general sense, it is contemplated that if the “gain” is represented as a complex value, it may be sufficient to represent the weights as a complex “gain” value instead of specifying both the gain and/or phase.

The instructions stored on the memory may further include modulating an ideal waveform sequence with the calculated weights to create a beam switched modulated ideal sequence. In an embodiment, the ideal waveform corresponds to a known waveform for a particular type of transmitted signal. In some embodiments, the instructions may further include comparing the modulated ideal sequence of the waveform of the signal to the actual measured waveform of the signal. In an embodiment, comparing the modulated ideal sequence of the waveform of the transmitted signal to the actual measured waveform of the transmitted signal includes correlating the modulated ideal sequence to the measured sequence to determine an angle of arrival that would generate beam switched samples most similarly resembling the measured samples for the steered beams.

The instructions stored on the memory may further include constructing a mapping between sets of weights utilized to modulate an ideal signal and angles of arrival that would cause an ideal signal to resemble to the modulated ideal signal. Since signal gain is dependent on the angle of arrival of a signal at a receiver device relative to the transmitter device, a mapping may be constructed that defines a signal gain sequence to a particular angle of arrival. Accordingly, when a signal arrives at an antenna from a specific angle, the antenna's gain may vary depending on the direction of the incoming signal relative to the antenna's main lobe. In an embodiment, the mapping may depend on the beam shapes during beamforming caused from beam switching, and the specific set of beams that are swept.

In an embodiment, the processing device 330 includes a mapping stored on the memory, such that the mapping defines a relationship between different sequence of weights and respective angles of arrival capable of causing the creation of each sequence of weights. In an embodiment, the sequence of weights is compared to the mapping to determine an angle of arrival of the transmitted signal.

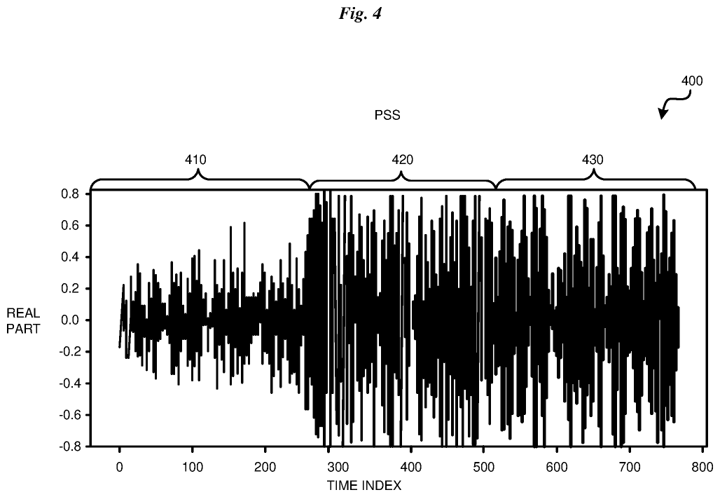

With reference to FIG. 4, this figure depicts a diagram of an example sequence of beam switched sets of received wave samples 400. In the illustrated embodiment, three sets of wave samples are shown within one communication symbol, a first set of wave samples 410, a second set of wave samples 420, and a third set of wave samples 430. In the illustrative embodiment, the communication symbol shown is a primary synchronization symbol (PSS) used in the 5G standard; however, use of this example is not intended to be limiting, but is instead used for descriptive purposes only. Instead, embodiments of the present disclosure could be applied to many other types of communication symbols.

Each of the three sets of received wave samples comprise a different amplitude based on the gain resulting from the direction of the beam shape. As shown in the illustrated embodiment, the first set of wave samples 410 includes a number of samples received while a receiver device is configured to capture a transmitted signal in a first direction, with a gain of +0.5, the second set of wave samples 420 includes a number of samples received while the receiver device is configured to capture a transmitted signal in a second direction, with a gain of +0.8, and the third set of wave samples 430 includes a number of samples received while the receiver device is configured to capture a transmitted signal in a third direction, with a gain of −0.8. The specific values of the gains are unknown at the receiver. In this illustrative embodiment, the specific beams chosen are linear phase-slope beams and thus the gains are real-valued, i.e., positive or negative valued, i.e., with phase of 0 or 180 degrees. Although only three sets of wave samples are shown corresponding to three different signal measuring direction configurations, it is contemplated herein than any number of sets of wave samples may be processed depending on the number of different angular directions in which the receiving device is configured. For example, if the receiver is configured for 100 directions within a single communication symbol, then 100 sets of wave samples may be received from the transmitting device within the same communication symbol.

If the receiver measures an incoming signal using a beam with a peak gain in the direction that the signal is received, then the received signal should have the highest gain. If the receiver measures the signal using a beam with a peak gain in a different direction than direction at which the signal is being received, then the waveform of the received signal will have a different gain and/or phase. It is contemplated herein that, when a finite number of beam directions are used, the highest gain might not indicate the angle of arrival (AoA), instead it might only indicate that the actual AoA is nearby to the direction of measurement. However, a particular sequence of gains will only be obtained based upon a particular AoA.

To further illustrate this point, suppose a measured signal has a particular gain when the signal is measured 10 degrees off from the actual AoA. In such a scenario, the measured signal may have the same particular gain when the signal is measured 10 off from the actual AoA in the opposite direction. In such a scenario, the gain alone does not determine the AoA since both measurement directions may provide the same gain. However, when multiple measurements of the signal are taken, each beam shape will provide a different gain, and more importantly, the sequence of measured gains will be unique to the actual AoA of the signal.

In an embodiment, an embodiment of the system determines a sequence of weights based on the measured gain of each set of wave samples. Suppose the system measures the gain based on three different directions, then the sequence of weights will include 3 weights. In an embodiment, the system applies the sequence of weights to a known ideal waveform, resulting in a modulated ideal waveform. In an embodiment, the system 400 correlates the modulated ideal waveform to the actual measured waveform to determine an angle of arrival that would generate beam switched samples most similarly resembling the measured samples for the steered beams.

As described above, in an embodiment, the system constructs a mapping between the angle of arrival and the set of weights. In an embodiment, the mapping may be based at least in part on the number of beams swept. In an embodiment, the mapping may be based at least in part on the beam shape of each beam. In some embodiments where the weights/gains for each beam are extracted from the corresponding waveform samples, the angle of arrival (AoA) is identified by finding the direction whose mapped weights best resemble the extracted weights. The mapping between angle of arrival (AoA) and the set of weights is determined by the specific choice of the set of beams used in the beam switching.

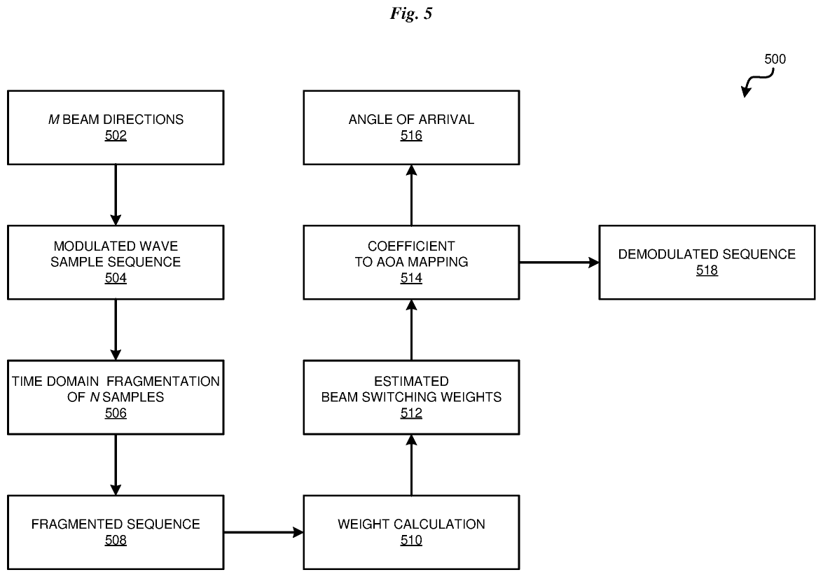

With reference to FIG. 5, this figure depicts a block diagram of an example process for estimating angle of arrival using sub-symbol beam switching in accordance with an illustrative embodiment.

At block 502, a number of beam directions (M) are configured using a phased array antenna system of a receiver device during transmission of a signal from a transmitter device to the receiver device. The number of beam directions depend on the number of beam switching operations that are performed during a period of time. In an embodiment, the period of time includes the duration of a single communication symbol. In an embodiment, the communication symbol is an OFDM symbol. For example, if beam switching is performed three times, then M=3. Although three beam switching operations are used for the purpose of simplicity, it is contemplated that the beam switching may be performed any number of times over the duration of a single communication symbol.

At block 504, a modulated wave sample sequence is received by the receiver device. Accordingly, the gain of the wave sample sequence received by the receiver device is modulated from performing beam switching M times over the duration of a single communication symbol. The specific gains applied during each beam is dependent on the angle of arrival as well as the shapes of the beams used. At block 506, the process performs a time domain fragmentation of the wave sample sequence to produce M sets of wave samples, each with N/M samples. Accordingly, each time a beam switching operation is performed, a set of wave samples is obtained defined by the period of time that the beam is formed in a particular shape as a result of the beam switching operation. For example, suppose beam switching is performed three times, then the wave sample sequence is fragmented into 3 sets of sub-symbol modulated wave samples. The process of fragmenting the modulated wave sample sequence into M sets of samples produces fragmented sequence 508.

At block 510, the process calculates a sequence of weights based upon the fragmented sequence 508. Further, the process of calculating a sequence of weights based upon the fragmented sequence produces a set of estimated beam switching weights 512. Further, the set of estimated beam switching weights is compared against coefficient-to-AoA mapping 514 to identify the angle of arrival 516 of the transmitted signal. At block 518, a demodulated wave sample sequence is retrieved. In some embodiments, the estimated beam switching weights in 512 for each fragment is obtained by correlating the measured fragment with the ideal waveform for that fragment.

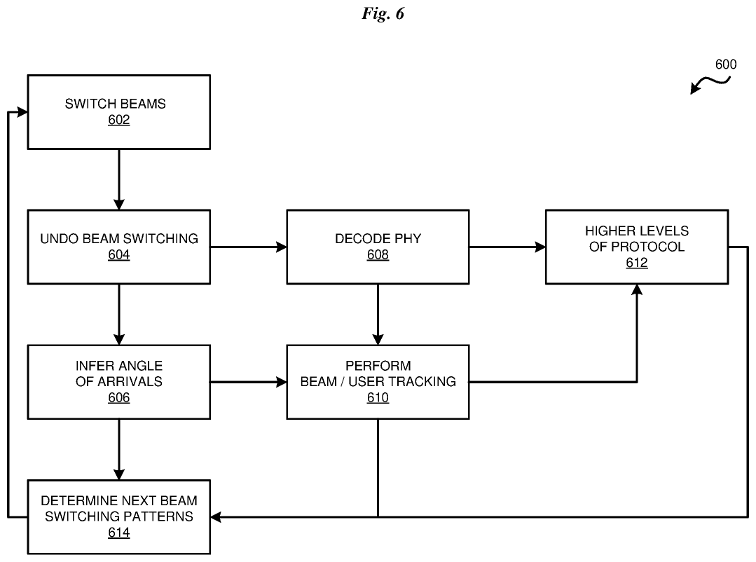

With reference to FIG. 6, this figure depicts a block diagram of an example process that incorporates a method for estimating angle of arrival of a signal. Some embodiments may operate with a known waveform such as synchronization symbols, pilot tones, while other embodiments may use waveforms with unknown data such as data payloads. The process uses sub-symbol beam switching in accordance with an illustrative embodiment.

At block 602, the process performs beam switching at the receiver to acquire modulated wave sample sequences based on the AoA of the signal and the specified beam shapes in the beam switching sequence.

At block 604, the process undoes the beam switching operations. This includes estimating the beam weights, including gain and/or phase/delay for each fragment of the waveform. Once the beam weights are estimated, the gain and phase/delay modulation in each fragment is undone, i.e., the inverse of the gain and/or phase/delay are applied to the received waveform. In a sense, the process in FIG. 5 from 506 to 518 is an example of undoing of beam switching operations when the waveform is a known signal.

At block 606, the process infers the angle of arrival. The estimated weights for each fragment are compared/correlated with the mapping of AoA to weights. At block 608, the process decodes the physical signal using the waveform samples after undoing of the beam switching. In a sense, the process in FIG. 5, specifically 514 to 516 is an example of inferring angle of arrival.

At block 612, the process utilizes the decoded signal for higher levels of wireless communication protocols. Suppose for example, the known waveform is a 5G primary synchronization signal (PSS). In such a case, the higher level of protocol may use the identified PSS ID (known as the “NID”) for network identification, identifying frame structures, creating payloads for future transmissions (e.g., Random Access Channel Transmissions), and so forth.

At block 610, upon having identified the angle of arrival of the transmitted beam, the process performs beam tracking and/or user tracking. Accordingly, once the angle of arrival is known, it becomes possible to track the location of a beam transmitted from a transmitting device, as well as the location of the transmitting device itself. In an embodiment, the beam tracking (as well as user tracking) may be performed by using the angle of arrival information, including the angle of arrival history, to determine the best beam direction for receiving the transmitted signal. In some embodiments, the estimated best beam direction is used for communication without performing beam switching for a period of time. The period of time is determined by the channel coherence time, movement of users and objects in the environment etc.

At block 614, the process determines next beam switching parameters for performing further beam switching. Accordingly, switching parameters for performing further beam switching enables a refined search for an angle of arrival of the received signal or for obtaining updated AoA for tracking, for example beyond the channel coherence time. In an embodiment, the next beam switching patterns are determined by using the current angle of arrival and selecting a set of directions to search for in the next received signal.

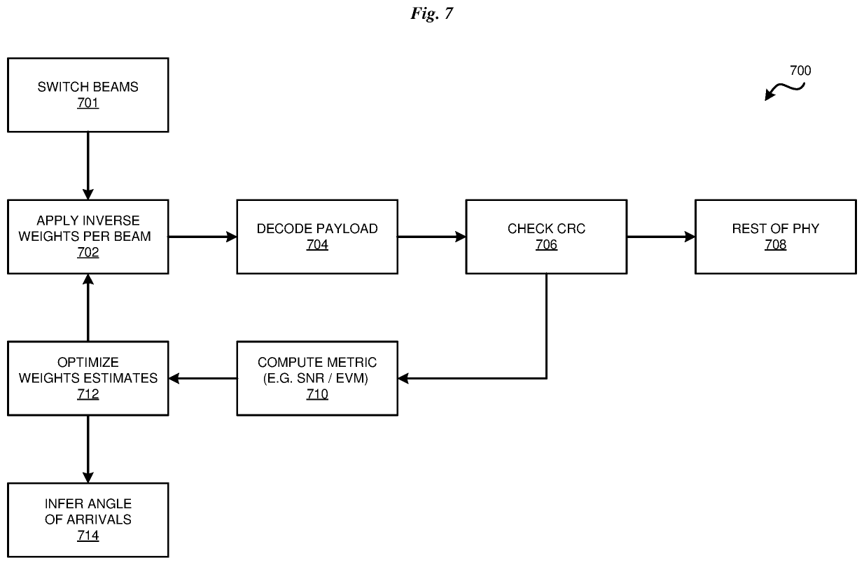

With reference to FIG. 7, this figure depicts a block diagram of an example process of a method for estimating angle of arrival of a signal with an unknown waveform using sub-symbol beam switching in accordance with an illustrative embodiment. In an embodiment, process 700 is an iterative process that includes applying a set of weights to a received signal, and checking whether the applied sets of weights enable decoding of the signal. In a sense, the iterative process including 702,704,706,710,712 implements the block 604 for “undoing beam switching” as well as a portion of 608 for decoding of the physical layer, when the underlying waveform is unknown. While the specific waveform is unknown, it is assumed that the waveform follows a known structure, for example data payloads in a communication protocol.

At step 701, the process performs beam switching at the receiver during reception of a signal. At step 702, the process takes as input the modulated waveform samples that are a result of beam switching at the receiver. The waveform is split into fragments corresponding to each beam. Step 702 applies an inverse sequence of weights to the waveform fragments to obtain an estimate of the waveform with beam switching undone. Initially, the input weights for step 702 may use predetermined initialization values.

At step 704, the payload is decoded and data is extracted from a received signal. In an embodiment, step 704 may be performed simultaneously as step 702, so that decoding physical layer is performed at the same time as undoing beam switching.

At step 706, a Cyclic Redundancy Check (CRC) is performed to detect errors in the data extracted in the received signal. Accordingly, performing the CRC enables a determination that the payload has been correctly decoded. Further, the CRC confirms that the information in the waveform was decoded correctly at step 704. This a hard pass/fail metric indicating that the received signal quality is suitable for the purpose of decoding.

At step 710, a metric is computed. In an embodiment, the metric includes a signal-to-noise ratio (SNR) metric. In another embodiment, the metric includes an error vector magnitude (EVM) metric. Accordingly, SNR and EVM are more granular/continuous metrics to assess the link quality. Even if the CRC is correct, there may be an opportunity to further improve the AoA estimate, which would result in a receiver beam with much better alignment to the transmitted signal. Such gradual improvements, or adjustments as the transmitter moves, would result in improved SNR and/or EVM.

At step 712, the sequence of weight estimated are optimized with the goal of optimizing the metric computed by 710. For example when SNR is maximized or EVM is minimized, the estimates of the weights per beam best reflect the impact of beam switching. Accordingly, after the CRC has been performed and the metric computed at step 710 confirms that the signal has been properly decoded, the sequence of weights may be optimized. At step 714, the angle of arrival of the signal is determined based on the optimized sequence of weights. Similar to 606, once the weights per fragment are estimated, the weights are compared, or correlated with the mapping of angle of arrival to weights in order to estimate the AoA that best provides the measure sequence of beam weights per fragment of waveform. Finally, at step 708, the remainder of the physical layer (PHY) is processed and decoded using the waveform samples with the beam switching undone.

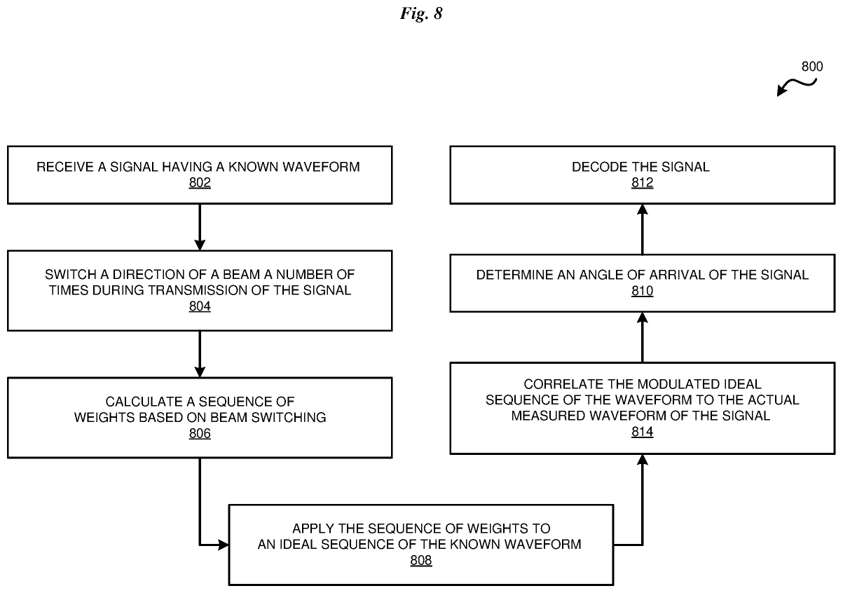

In some embodiments, process 700 may be combined with process 600. For example, the result of process 600 may enable a determination of the direction of a beam and/or a user. Once the direction of a beam and/or a user is known, process 700 may be implemented to continuously track the beam and/or user upon determining that any change to the angle of arrival has been observed. Accordingly, in the context of tracking, once a main angle of arrival is computed, a smaller angular step may be used for a subsequent communication symbol. Further, if a smaller angular sweep is used, then the distortion in the signal will be low enough to enable normal decoding of the signal. The decoded data can then be used in part to compute beam switching weights and the angle of arrivals. If the decoding fails, for example the CRC produces an incorrect result, the full process beginning from the first step of process 600 may be performed to determine a main angle of arrival. In some embodiments, once a valid data payload is decoded with valid CRC, the waveform can be considered as becoming “known” and thus embodiments intended for received signals with known waveforms such as in FIG. 5 and FIG. 8 can also be applied.

With reference to FIG. 8, this figure depicts a flowchart of an example process 800 for estimation of angle or arrival using sub-symbol beam switching in accordance with an illustrative embodiment. In a particular embodiment, the AoA estimation module 200 of FIG. 1 carries out the process 800. Specifically, this embodiment can be used for waveforms with known data. It is an alternate embodiment to FIG. 5.

In the illustrated embodiment, at block 802, the process receives a data stream corresponding to a transmitted signal. In some embodiments, the signal is signal with a known waveform. In an embodiment, an analog electromagnetic signal is transmitted from a transmitter device and is received by a receiver device. When the signal is received by the receiver device, an analog-to-digital (ADC) converter may be utilized to convert the analog signal into a digital bit representation of the analog signal. Further, the data stream comprises the digital signal (i.e., the digital bit representation of the analog signal), which comprises a plurality of sets of wave samples corresponding to the transmitted signal.

At step 804, the process performs a beam switching pattern to adjust a shape of a received beam a number of times during the reception of the signal. In an embodiment, the process adjusts the shape of a beam a number of times for the duration of a single communication symbol length of time. In an embodiment, the process steers the beam using a receiver that includes a phased array system capable of rapidly steering the beam over multiple directions within the symbol. Further, for every beam direction that is configured, there is a gain profile created for each direction. Accordingly, depending on the angle of incidence, which is determined by the beam direction, the receiver experiences a different gain depending on the beam angle. Thus, the amplitude of the waveform is dependent in part on the shape of the beam that is chosen.

At step 806, the process calculates a sequence of weights based at least on the result of the beam switching process performed. Accordingly, since each direction of each beam has an impact on the gain, each set of samples corresponding to each beam direction, respectively, may be associated with a particular weight. An embodiment of the disclosed process calculates a weight based on the gain for each set of wave samples, and constructs a sequence of weights based through sequentially combining each gain value.

At step 806, the process applies the sequence of weights to an ideal sequence of a known waveform. In a particular embodiment, the waveform of the transmitted signal is known. In some such embodiments, the sequence of weights is applied to the ideal sequence of the known waveform to construct a beam switching modulated ideal sequence.

At step 808, the process compares the modulated ideal sequence of the waveform of the signal to the actual measured waveform of the signal. In an embodiment, the comparing the modulated ideal sequence of the waveform of the transmitted signal to the actual measured waveform of the transmitted signal includes correlating the modulated ideal sequence to the measured sequence to determine an angle of arrival that would generate beam switched samples most similarly resembling the measured samples for the steered beams. At step 810, the process determines the angle of arrival of the signal. At step 812, the process decodes the signal and recovers beam samples (without weights) for utilization in higher protocol level wireless communication processing as well as the estimated angle of arrival. It is noted that FIG. 8 is a subset of FIG. 6 and specifically implements 602,604,606 altogether.

Although some embodiments of the present disclosure reference a single angle of arrival (AoA) and the estimation of a single AoA, these example embodiments are not intended to limit the scope of the present disclosure. For example, it is contemplated herein embodiments of the present disclosure may be modified for use in multi-path scenarios. Accordingly, in environments that include multiple signal paths, the electromagnetic waves from the transmitter can have reflections, refractions, and/or diffractions from objects, and may reach the receiver array from multiple directions. For example, one path of the multiple paths may be a line of sight of the signal. Also, some paths may have multiple reflections. Further, each path may be associated with particular amplitude/gain and a phase shift/delay. Further, each path will also include a particular AoA.

In a multi-path embodiment, with a given beam configuration at the receiver, the waveform is a linear combination of the signal from each path with the amplitude/gain and phase/delay from the incoming wave and the gains and phase/delay from the beam shape for each AoAs for each of multiple paths. When beam switching is applied, each fragment of the waveform is a linear combination of the incoming signal amplitude/phase/delay and the beam gain/phase/delay for each path of the multiple paths and their corresponding AoAs.

In the context of FIG. 6, when multi-path is present, block 604 estimates the weights based on amplitude, phase, delay for each path of the multi-path component present for all the beams used in the beam switching. Then block 606 infers the angle of arrival for each of the multi-path components by correlating to the known beam pattern shapes, in a similar manner as described with reference to a single path scenario.

In the context of FIG. 7, similarly, when multi-path is present, block 712 and the block 702 may use multi-path models. Once a valid CRC is achieved and the amplitude, phase, and/or delay for each multipath component are optimized using an appropriate metric in block 710, the angle of arrival for each of the paths may be inferred in block 714 by correlating to the known beam pattern shape.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
receiving a data stream comprising a plurality of sets of wave samples over a defined period of time, wherein receiving the data stream comprises receiving a transmitted signal at a receiver device from a transmitter device, and wherein the receiver device comprises an antenna array;
adjusting a beam shape at the receiver device a number of times while the transmitted signal is being received during the defined period of time using the antenna array,
wherein adjusting the beam shape a number of times produces a modulated plurality of wave samples based on different beam shapes; and
determining the angle of arrival of the transmitted signal based at least in part on the modulated plurality of wave samples.

2. The computer-implemented method of claim 1, wherein the defined period of time comprises a duration of a single communication symbol.

3. The computer-implemented method of claim 2, wherein the communication symbol comprises an orthogonal frequency-division multiplexing (OFDM) symbol.

4. The computer-implemented method of claim 1, wherein the computer-implemented method further comprises a post-processing technique, wherein the post-processing technique comprises estimation and inversion of at least one of gains and delays corresponding to each beam pattern.

5. The computer-implemented method of claim 4, wherein the at least one of gains and delays are correlated with the beam pattern used in beam switching to calculate the angle of arrival.

6. The computer-implemented method of claim 1, wherein the computer-implemented method further comprises extracting a sequence of weights from the modulated plurality of wave samples.

7. The computer-implemented method of claim 6, wherein the determining the angle of arrival of the transmitted signal further comprises:
applying the sequence of weights to an ideal waveform of the transmitted signal to create a modulated ideal waveform; and
comparing the modulated ideal waveform to the plurality of sets of wave samples to determine the angle of arrival corresponding to each set of the plurality of sets of wave samples.

8. The computer-implemented method of claim 6, wherein the determining the angle of arrival of the transmitted signal further comprises:
establishing a mapping between a plurality of sequences of weights and a plurality of angles of arrival corresponding to the plurality of sequences of weights; and
comparing the sequence of weights extracted from the modulated plurality of wave samples against the mapping to determine the angle of arrival.

9. The computer-implemented method of claim 1, wherein the transmitted signal is received at the receiver device from a plurality of signal paths, and the computer-implemented method further comprises determining a plurality of angles of arrival corresponding to the plurality of signal paths.

10. A computer program product comprising one or more computer readable storage media, and program instructions collectively stored on the one or more computer readable storage media, the program instructions executable by a processor to cause the processor to perform operations comprising:
receiving a data stream comprising a plurality of sets of wave samples over a defined period of time, wherein receiving the data stream comprises receiving a transmitted signal at a receiver device from a transmitter device, and wherein the receiver device comprises an antenna array;
adjusting a beam shape at the receiver device a number of times while the transmitted signal is being received during the defined period of time using the antenna array,
wherein adjusting the beam shape a number of times produces a modulated plurality of wave samples based on different beam shapes; and
determining the angle of arrival of the transmitted signal based at least in part on the modulated plurality of wave samples.

11. The computer program product of claim 10, wherein the stored program instructions are stored in a computer readable storage device in a data processing system, and wherein the stored program instructions are transferred over a network from a remote data processing system.

12. The computer program product of claim 10, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

13. The computer program product of claim 10, wherein the defined period of time comprises a duration of a single OFDM communication symbol.

14. The computer program product of claim 10, further comprising a post-processing technique, wherein the post-processing technique comprises estimation and inversion of at least one of gains and delays corresponding to each beam pattern.

15. The computer program product of claim 14, wherein the at least one of gains and delays are correlated with a beam pattern used in beam switching to calculate the angle of arrival.

16. The computer program product of claim 10, wherein the computer program product further comprises extracting a sequence of weights from the modulated plurality of wave samples.

17. The computer program product of claim 16, wherein determining the angle of arrival of the transmitted signal further comprises:
applying the sequence of weights to an ideal waveform of the transmitted signal to create a modulated ideal waveform; and
comparing the modulated ideal waveform to the plurality of sets of wave samples to determine the angle of arrival corresponding to each set of the plurality of sets of wave samples.

18. The computer program product of claim 16, wherein determining the angle of arrival of the transmitted signal further comprises:
establishing a mapping between a plurality of sequences of weights and a plurality of angles of arrival corresponding to the plurality of sequences of weights; and
comparing the sequence of weights extracted from the modulated plurality of wave samples against the mapping to determine the angle of arrival.

19. A computer system comprising a processor and one or more computer readable storage media, and program instructions collectively stored on the one or more computer readable storage media, the program instructions executable by the processor to cause the processor to perform operations comprising:
receiving a data stream comprising a plurality of sets of wave samples over a defined period of time, wherein the receiving the data stream comprises receiving a transmitted signal at a receiver device from a transmitter device, and wherein the receiver device comprises an antenna array;
adjusting a beam shape at the receiver device a number of times while the transmitted signal is being received during the defined period of time using the antenna array,
wherein adjusting the beam shape a number of times produces a modulated plurality of wave samples based on different beam shapes;
extracting a sequence of weights from the modulated plurality of wave samples; and
determining the angle of arrival of the transmitted signal based at least in part on the sequence of weights extracted from the modulated plurality of wave samples.

20. The computer system of claim 19, wherein determining the angle of arrival further comprises:
extracting a sequence of weights from the modulated plurality of wave samples;
establishing a mapping between a plurality of sequences of weights and a plurality of angles of arrival corresponding to the plurality of sequences of weights; and
comparing the sequence of weights extracted from the modulated plurality of wave samples against the mapping to determine the angle of arrival.
